(19) United States
(12) Patent Application Publication
(10) Pub. No.: US 2024/0308337 A1
(43) Pub. Date: Sep. 19, 2024

(54) DRIVER POSITION ASSIST SYSTEM AND METHOD

(71) Applicant: Ford Global Technologies, LLC, Dearborn, MI (US)

(72) Inventors: Yashanshu Jain, Dearborn, MI (US); Steven Yellin Schondorf, Dearborn, MI (US); David Michael Herman, West Bloomfield, MI (US); Ryan Sorsby, Canton, MI (US); Zeina Byrom, Dearborn, MI (US); Mahesh Umasankar, Dearborn, MI (US)

(73) Assignee: Ford Global Technologies, LLC, Dearborn, MI (US)

(21) Appl. No.: 18/183,580

(22) Filed: Mar. 14, 2023

(51) Int. Cl. B60K 35/00; B60R 16/037; G06V 20/59

(52) U.S. Cl. CPC B60K 35/00; B60R 16/037; G06V 20/597; B60K 35/28; B60K 35/65; B60K 2360/177; B60K 2360/21

(57) ABSTRACT

A driver position assist system is disclosed. The driver position assist system may include a transceiver configured to receive a vehicle component configuration from a vehicle. The driver position assist system may further include a processor configured to obtain the vehicle component configuration from the transceiver. The processor may be further configured to estimate a vehicle user position inside the vehicle based on the vehicle component configuration. The processor may further determine whether a vehicle user head portion is in a driver-facing camera field of view (FOV) based on the estimation of the vehicle user position. The processor may additionally determine an updated vehicle component configuration based on the vehicle user position, when the vehicle user head portion is in not in the camera FOV. Furthermore, the processor may transmit the updated vehicle component configuration to a user interface.

### TECHNICAL FIELD

The present disclosure relates to a driver position assist system and method, and more particularly, to a system and method to assist a driver in updating a vehicle component configuration so that a driver head may be in a driver facing camera field of view (FOV).

### BACKGROUND

Many modern vehicles include driver alertness detection systems that determine whether a vehicle driver is focusing on the road while driving. A driver alertness detection system (“system”) generally outputs an audio and/or visual alarm when the system determines that the driver may not be focused and may cause vehicle braking via an Advanced Driver Assistance Systems (ADAS). The system includes a driver facing camera that monitors driver's gaze and assists the system in determining driver alertness level. The driver facing camera is typically positioned in proximity to a vehicle steering wheel so that a driver head may be in a camera field of view (FOV).

For optimum system operation, it is imperative that the driver head is in the camera FOV so that the camera may capture driver eye gaze and/or head orientation precisely. However, in some scenarios, the driver head may not be in the camera FOV for one or more reasons. For example, the driver head may not in the camera FOV due to driving road conditions, naturalistic driver's head movement, driver's sitting area position or inclination, steering column position, and/or combination thereof. The system may incorrectly determine the driver head orientation when the driver head is not in the camera FOV, which may result in false alarm by the system.

Conventional systems implement various approaches to ensure that the driver head is in the camera FOV. For example, the system may determine whether the driver head is in the camera FOV at the start of every drive, and provide notification to the driver to calibrate the camera and/or adjust vehicle sitting area and steering column when the driver head is not in the camera FOV. Calibrating camera (or sitting area/steering column) frequently or at the start of every drive may require additional work from the user, and hence result in user inconvenience.

Thus, there is a need for a system and method to provide assistance to the driver so that the driver head may be in the camera FOV.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example driver position assistance system, in accordance with the present disclosure.

FIG. 3 depicts an example embodiment of a field of view captured by a driver-facing camera, in accordance with the present disclosure.

FIG. 4 depicts a flow diagram of an example method for providing driver position assistance, in accordance with the present disclosure.

### DETAILED DESCRIPTION

### Overview

The present disclosure describes a driver position assistance system (“system”) that may assist a driver to adjust driver position inside a vehicle so that a driver head may be in a driver-facing camera field of view (FOV). Specifically, the system may assist the driver to adjust one or more vehicle component configurations that may cause the driver head to come in the camera FOV. The vehicle component configurations may include, for example, sitting area position, steering column position, and/or the like. Of note, such adjustments should always be implemented in accordance with the owner manual and safety guidelines.

The system may obtain “existing” or “current” vehicle component configurations from the vehicle, and may estimate a driver sitting position inside the vehicle based on the obtained vehicle component configurations. Responsive to estimating the driver sitting position, the system may determine whether the driver head is in the camera FOV. Further, the system may predict one or more reasons for the driver head not being in the camera FOV, based on a determination that the driver head may not be in the camera FOV. Responsive to determining the reason(s), the system may determine an “updated” vehicle component configuration (as a solution) so that the driver head may come in the camera FOV. For example, the system may determine moving a sitting area position from a raised alignment to a lower alignment, as the updated vehicle component configuration. The system may then transmit the updated vehicle component configuration to a user interface (e.g., a vehicle infotainment system or a driver device), and assist the driver to update the vehicle component configuration.

In some aspects, the system may estimate the driver sitting position inside the vehicle by obtaining (or predicting) driver profile, and generating a driver virtual manikin based on the driver profile. The driver virtual manikin may imitate the driver in virtual reality inside the vehicle. In addition, the system may generate a virtual vehicle model based on the obtained vehicle component configurations. Responsive to generating the driver virtual manikin and the virtual vehicle model, the system may position or superimpose the driver virtual manikin on the virtual vehicle model to estimate/predict the driver sitting position inside the vehicle. In further aspects, the system may detect driver body parts (driver head top, driver chin, etc.) present in the camera FOV to estimate the driver sitting position.

The present disclosure provides a driver position assistance system that automatically determines an optimum driver position inside the vehicle so that the driver head may be in the camera FOV. In addition, the determination of the optimum driver position enhances image quality as the optimum driver position maintains a desirable distance from a camera axis center. For example, in the optimum driver position, driver head center portion may be in proximity to the camera axis center, thereby ensuring enhanced/high quality of driver head image. By ensuring that the driver head is in the camera FOV (and the driver head image is of high quality), the system may ensure that false alarms generated by a vehicle driver alertness detection system are minimized. In addition, the system reduces driver frustration and uncertainty to position driver's head in the camera FOV, and automatically determines the optimum driver position and assists the driver to achieve the optimum driver position. Further, the system eliminates the need for the driver to calibrate the camera (or sitting area/steering column) at the start of each drive or frequently, thus enhancing user convenience.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

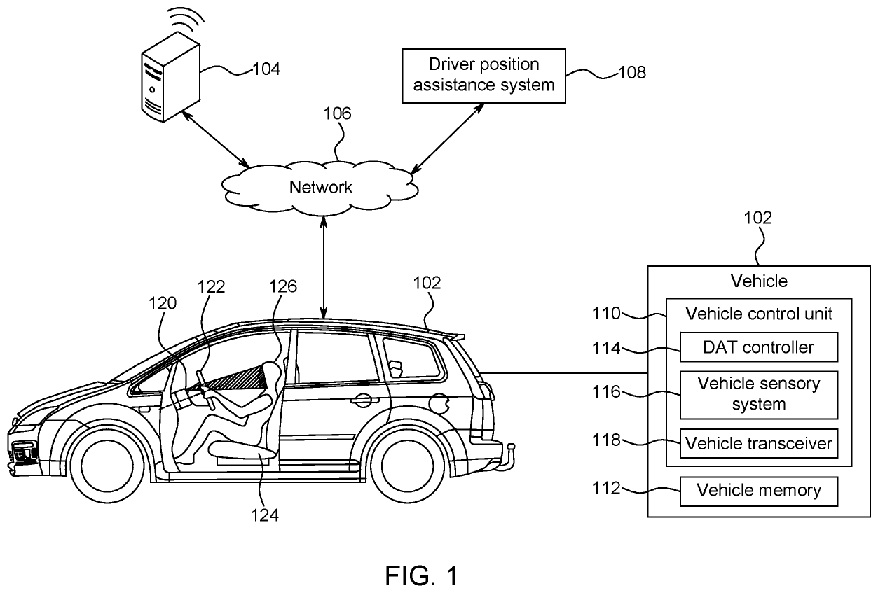

FIG. 1 depicts an example environment 100 in which techniques and structures for providing the systems and methods disclosed herein may be implemented. The environment 100 may include a vehicle 102 and a server 104, communicatively connected with each other via one or more networks 106 (or a network 106). The environment 100 may further include a driver position assistance system 108 that may communicatively couple with the vehicle 102 and the server 104 via the network 106. In some aspects, the driver position assistance system 108 may be part of the vehicle 102. In other aspects, the driver position assistance system 108 may be part of the server 104.

The vehicle 102 may take the form of any passenger or commercial vehicle such as, for example, an off-road vehicle, a car, a crossover vehicle, a van, a minivan, a bus, a truck, etc. Further, the vehicle 102 may include any powertrain such as, for example, a gasoline engine, one or more electrically-actuated motor(s), a hybrid system, etc. Furthermore, the vehicle 102 may be a manually driven vehicle and/or be configured and/or programmed to operate in a fully autonomous (e.g., driverless) mode (e.g., Level-5 autonomy) or in one or more partial autonomy modes which may include driver assist technologies.

The vehicle 102 may include a Vehicle Control Unit (VCU) 110 and a vehicle memory 112 (that may be part of an on-board vehicle computer, not shown). The VCU 110 may include a plurality of units including, but not limited to, a Driver Assistance Technologies (DAT) controller 114, a vehicle sensory system 116, a vehicle transceiver 118, a plurality of electronic control units (ECUs, not shown) and the like. In some aspects, the vehicle transceiver 118 may be outside the VCU 110. The VCU 110 may be configured and/or programmed to coordinate data within vehicle 102 units, connected servers (e.g., the server 104), other vehicles (not shown in FIG. 1) operating as part of a vehicle fleet and the driver position assistance system 108.

In some aspects, the DAT controller 114 may provide Level-1 through Level-4 automated driving and driver assistance functionality to a vehicle user. The vehicle sensory system 116 may include one or more vehicle sensors including, but not limited to, a steering wheel sensor, a Radio Detection and Ranging (radar“) sensor, sitting area buckle sensors, sitting area sensors, a Light Detecting and Ranging (lidar”) sensor, door sensors, proximity sensors, temperature sensors, torque measurement unit, capacitance measurement unit (not shown), etc. The vehicle sensory system 116 may be configured to monitor vehicle inside portion and vehicle outside portion. A person ordinarily skilled in the art may appreciate that the sitting area sensors may be configured to measure sitting area height, sitting area inclination etc., and the steering wheel sensor may measure steering wheel position or orientation. For example, the steering wheel sensor may measure an upward or downward steering wheel rotation relative to a steering wheel nominal position and/or steering wheel torque applied by driver. Further, one or more vehicle features or units, e.g., driver gesture recognition or monitoring units (not shown) may use inputs from the vehicle sensory system 116 (e.g., sensor data) to perform respective human-machine interface (HMI) functions.

The vehicle 102 may further include a driver-facing camera 120 (or a camera 120) that may be mounted in proximity to a steering wheel 122, as shown in FIG. 1. In some aspects, the camera 120 may be mounted between the steering wheel 122 and a vehicle cluster. The camera 120 may be a driver state monitoring camera (DSMC) that may be configured to capture driver images when a driver 126 drives the vehicle 102 or sits at a driver sitting area 124. The camera 120 may be mounted in proximity to the steering wheel 122 so that a driver head may be in a camera 120 field of view (FOV). In other aspects, the camera 120 may be mounted in other vehicle positions.

The vehicle transceiver 118 may be configured to receive measurements from the vehicle sensory system 116 and the driver images captured by the camera 120, and transmit the measurements and images to the driver position assistance system 108 and/or the server 104 via the network 106.

The vehicle memory 112 may store programs in code and/or store data for performing various vehicle operations in accordance with the present disclosure. The vehicle memory 112 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc. In some aspects, the vehicle memory 112 may store the measurements taken from the vehicle sensory system 116 and the driver images captured by the camera 120.

A person ordinarily skilled in the art may appreciate that the vehicle architecture shown in FIG. 1 may omit certain vehicle units and/or vehicle computing modules. It should be readily understood that the environment depicted in FIG. 1 is an example of a possible implementation according to the present disclosure, and thus, it should not be considered limiting or exclusive.

The network 106 illustrates an example communication infrastructure in which the connected devices discussed in various embodiments of this disclosure may communicate. The network(s) 106 may be and/or include the Internet, a private network, public network or other configuration that operates using any one or more known communication protocols such as, for example, transmission control protocol/Internet protocol (TCP/IP), Bluetooth®, Bluetooth® Low Energy, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The server 104 may be part of a cloud-based computing infrastructure and may be associated with and/or include a Telematics Service Delivery Network (SDN) that provides digital data services to the vehicle 102 and other vehicles (not shown in FIG. 1) that may be part of a vehicle fleet. In some aspects, the server 104 may store the measurements and the driver images received from the vehicle 102.

In some aspects, the vehicle 102 may be configured to determine whether the driver 126 is focusing on the road while driving the vehicle 102. Specifically, the vehicle 102 may include a driver alertness detection system (which may be same as the DAT controller 114 or may be a part of the DAT controller 114) that may obtain the driver images captured by the camera 120, and determine a driver head orientation based on the obtained images. Responsive to determining the driver head orientation, the driver alertness detection system may determine whether the driver head (or eyes) is oriented towards an on-road windshield (and hence whether the driver 126 is focusing on the road) or if the driver head (or eyes) is oriented away from the on-road windshield (and hence if the driver 126 is not focused on the road). The driver alertness detection system may output an audio and/or visual alarm (e.g., via a vehicle infotainment system or a user device, not shown) when the driver 126 may not be focused on the road. The alarm may include a prompt or a request for the driver 126 to focus on the road.

In some aspects, the driver position assistance system 108 may be configured to obtain the measurements from the vehicle sensory system 116, via the vehicle transceiver 118, when a count of alarms outputted by the driver alertness detection system exceeds a predefined threshold. For example, the driver position assistance system 108 may obtain the measurements when the driver alertness detection system outputs more than 10 alarms within a time duration when the driver 126 drives the vehicle 102 for 100 miles. In other aspects, the driver position assistance system 108 may obtain the measurements at a predefined frequency, e.g., every 24 hours, or after every 100 miles drive.

In some aspects, the driver position assistance system 108 may obtain the measurements to determine one or more reasons for the alarms that the driver alertness detection system may output. Specifically, the driver position assistance system 108 may determine whether the driver 126 may not actually be focused on the road or whether the driver alertness detection system may be outputting false alarms. In some aspects, the driver alertness detection system may output false alarms when the driver head (completely or partially) may not be in the camera 120 FOV. A person ordinarily skilled in the art may appreciate that the driver alertness detection system may incorrectly determine the driver head orientation when the driver head is not in the camera 120 FOV, which may result in false alarms. Although the present disclosure describes an aspect where the driver alertness detection system determines driver head position not being in the camera 120 FOV as one reason for false alarms, the driver alertness detection system may be configured to determine other reasons for false alarms as well, e.g., sun glare in capture images, foreign object obstruction in the camera 120 FOV, and/or the like.

The driver position assistance system 108 may be configured to determine whether the driver alertness detection system may be outputting false alarms due to driver head not being in the camera 120 FOV. Responsive to determining that the driver head may not be in the camera 120 FOV, the driver position assistance system 108 may determine one or more reasons for the driver head not being the camera 120 FOV. For example, the driver position assistance system 108 may determine whether the sitting area 124 is too high or too low resulting in the driver head moving outside of the camera 120 FOV. Further, the driver position assistance system 108 may determine whether the steering column position is up or down relative to the steering wheel nominal position, resulting in camera 120 movement beyond a driver head focus.

In further aspects, the driver position assistance system 108 may determine whether the driver alertness detection system may be outputting false alarms due to the driver wearing eye blocking glasses, face-covering masks, etc. A person ordinarily skilled in the art may appreciate that the driver alertness detection system may not be able to correctly determine the driver head orientation (which may result in false alarms) from the driver images that the camera 120 may capture, when the driver wears eye blocking glasses, face-covering masks, etc. In further aspects, the driver position assistance system 108 may determine whether the driver alertness detection system may be outputting false alarms due to driver hand position on the steering wheel 122. A person ordinarily skilled in the art may appreciate that the driver alertness detection system may not be able to correctly determine the driver head orientation (which may result in false alarms) from the driver images that the camera 120 may capture, when the driver hand position obstructs the camera 120 FOV.

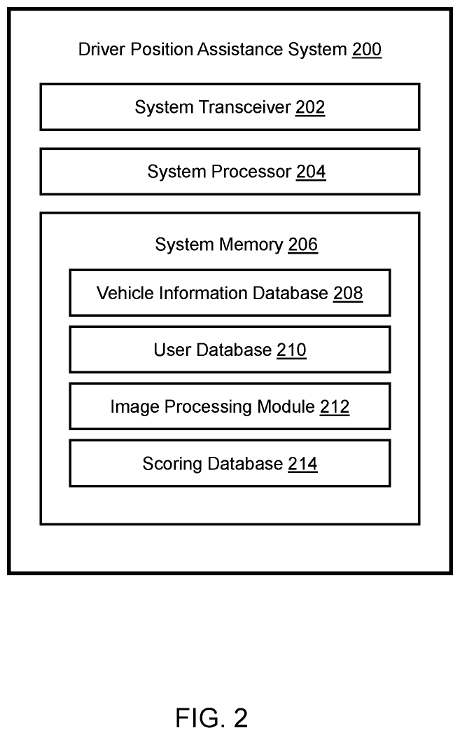

The driver position assistance system 108 may determine the reasons for false alarms (as described above) by obtaining the measurements (e.g., sitting area 124 position information, steering column position information, etc.) from the vehicle sensory system 116. Responsive to obtaining the above-mentioned information, the driver position assistance system 108 may “predict” driver position or posture inside the vehicle 102. The driver position assistance system 108 may further determine whether the driver head may be in the camera 120 FOV based on the prediction. When the driver position assistance system 108 determines that the driver head may not be in the camera 120 FOV, the driver position assistance system 108 may determine the corresponding reason(s) and recommend one or more changes to vehicle 102 component configurations to bring the driver head in the camera 120 FOV. For example, when the driver position assistance system 108 determines that the reason may be the sitting area 124 position (e.g., the sitting area 124 may be raised high), the driver position assistance system 108 may recommend an updated sitting area 124 position (e.g., moving the sitting area 124 lower) to bring the driver head in the camera 120 FOV. Similar recommendations may be made to the position of the seat back rest (e.g., lean forward or lean back), the steering column position (e.g., raise or lower), etc. The driver position assistance system 108 may share the recommendation(s) to the driver via the vehicle infotainment system or the user device. The details of the driver position assistance system 108 may be understood in conjunction with FIGS. 2-5.

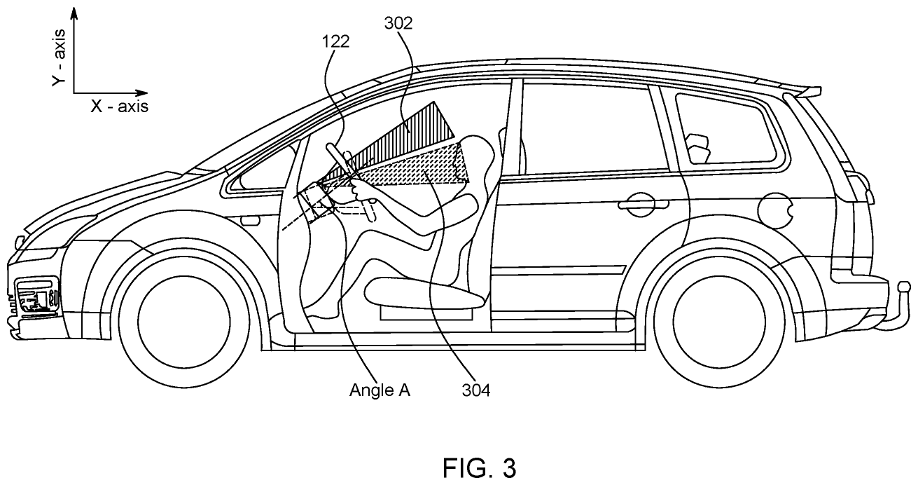

FIG. 2 depicts a block diagram of an example driver position assistance system 200 (system 200) in accordance with the present disclosure. While explaining FIG. 2, references may be made to FIG. 3. In particular, FIG. 3 depicts an example embodiment of a field of view captured by a driver-facing camera, in accordance with the present disclosure.

The system 200 may be same as the driver position assistance system 108. In some aspects, the system 200 may be located inside the vehicle 102 and communicatively connected to the server 104 via the network 106. In other aspects, the system 200 may be located inside the server 104 and communicatively connected to the vehicle 102 via the network 106.

The system 200 may include a system transceiver 202, one or more system processors 204 (or a system processor 204) and a system memory 206. The system transceiver 202 may be configured to transmit and receive information to and from the vehicle 102 and/or the server 104 via the network 106.

The system processor 204 may be disposed in communication with one or more memory devices, e.g., the system memory 206 and/or one or more external databases (not shown in FIG. 2). The system processor 204 may utilize the system memory 206 to store programs in code and/or to store data for performing system operations in accordance with the disclosure. The system memory 206 may be a non-transitory computer-readable memory storing a driver position assistance program code. The system memory 206 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.

In some aspects, the system memory 206 may include a plurality of modules and databases including, but not limited to, a vehicle information database 208, a user database 210, an image processing module 212, and a scoring database 214. The modules, as described herein, may be stored in the form of computer-executable instructions, and the system processor 204 may be configured and/or programmed to execute the stored computer-executable instructions for performing driver position assistance system functions in accordance with the present disclosure.

In operation, the system 200 may be configured to provide driver position assistance to the driver 126. Specifically, in an exemplary aspect, the camera 120 may capture driver images when the driver drives the vehicle 102, as described in conjunction with FIG. 1. The DAT controller 114 (or the driver alertness detection system described in conjunction with FIG. 1) may obtain the driver images from the camera 120, and determine whether the driver may not be focused on the road based on the obtained images. Responsive to determining that the driver may not be focused on the road, the DAT controller 114 may provide an alert/alarm to the driver (via the vehicle infotainment system or the user device, not shown) and request the driver to focus on the road.

In some aspects, the DAT controller 114 may be additionally configured to calculate a count of alerts provided to the driver 126. The DAT controller 114 may calculate the count of alerts when the driver 126 drives the vehicle 102 for a predefined distance (e.g., 100 miles) or a predefined time duration (e.g., two hours). In additional aspects, the DAT controller 114 may determine whether the count of alerts exceeds a threshold count within the predefined distance or the predefined time duration. For example, the DAT controller 114 may determine whether the count of alerts exceeds 10 in the last 100 miles that the driver 126 has driven the vehicle.

Responsive to determining that the count of alerts exceeds the threshold count, the DAT controller 114 may collect/obtain one or more inputs from the vehicle sensory system 116 (e.g., sensor data). In particular, the DAT controller 114 may obtain one or more vehicle component configurations from the vehicle sensory system 116. The vehicle component configurations may include, but are not limited to, the sitting area 124 configuration (e.g., sitting area 124 height, sitting area 124 inclination, etc.), steering column configuration (e.g., whether the steering column is aligned upwards, downwards, outwards or inwards), etc. The DAT controller 114 may be further configured to transmit, via the vehicle transceiver 118, the vehicle component configurations to the system transceiver 202.

Although the description above describes an aspect where the DAT controller 114 collects the inputs from the vehicle sensory system 116 (e.g., sensor data) when the count of alerts exceeds the threshold count, the present disclosure is not limited to the DAT controller 114 collecting the inputs based only on the count of alerts. In some aspects, the DAT controller 114 (or any other vehicle unit) may perform more (or less) complex low-level perception and analytics calculation (which may or may not be related to count of alerts) to determine whether a predefined condition is met. The DAT controller 114 may collect the inputs from the vehicle sensory system 116 when the DAT controller 114 determines that the predefined condition is met.

The system processor 204 may obtain the vehicle component configurations from the system transceiver 202, and store the vehicle component configurations in the vehicle information database 208. In some aspects, the system processor 204 may be configured to predict or estimate one or more reasons for the alerts based on the obtained vehicle component configurations. In particular, the system processor 204 may predict whether the DAT controller 114 may have provided the alerts due to the vehicle component configurations (e.g., due to sitting area 124 position, steering column position, and/or the like) or due to driver not being focused on the road, based on the obtained vehicle component configurations. The process of predicting the reason may be understood as follows.

In some aspects, the system processor 204 may obtain a user profile (or a driver profile) from the vehicle memory 112 or the server 104, via the system transceiver 202. The driver profile may include driver body information such as height, etc. The vehicle memory 112 or the server 104 may receive the driver profile from the driver 126 (e.g., from the user device associated with the driver 126). The system processor 204 may obtain the driver profile and may store the profile in the user database 210.

In other aspects, the system processor 204 may obtain one or more inputs from the vehicle 102 (e.g., sensor data) and may predict the driver profile, specifically height, etc., based on the obtained inputs. For example, the system processor 204 may obtain one or more driver images from internal or external vehicle cameras or sensors (not shown), and may predict the driver profile from the obtained driver images. In this case, the driver 126 may not be required to provide the driver profile to the vehicle memory 112 or the server 104. Although the present disclosure describes the above-mentioned ways to determine the driver profile, there may be other ways to determine the driver profile and the description provided above should not be construed as limiting the present disclosure scope.

Responsive to obtaining the vehicle component configurations from the DAT controller 114 and the driver profile from the vehicle memory 112, the server 104 or the vehicle cameras, the system processor 204 may estimate a driver position inside the vehicle 102. In particular, the system processor 204 may generate, via the image processing module 212, a vehicle 102 interior portion virtual model based on the vehicle component configurations, and a driver virtual manikin based on the driver's profile (e.g., based on driver's height). In some aspects, the system processor 204 may obfuscate the driver profile (e.g., by categorizing the driver profile as a non-gendered user having 75^{th} percentile adult body, and/or the like) when the system processor 204 generates the driver virtual manikin, to maintain confidentiality of drive profile and ensure privacy.

In an exemplary aspect, the system processor 204 may generate the vehicle 102 interior portion virtual model and the driver virtual manikin by using Computer-Aided Design (CAD) data and geometric constraints, and/or by using one or more virtual model and manikin templates that may be pre-stored in the system memory 206. Responsive to driver virtual manikin and vehicle 102 interior portion virtual model generation, the system processor 204 may position or superimpose, via the image processing module 212, the driver virtual manikin on the vehicle 102 interior portion virtual model. Specifically, the system processor 204 may superimpose the driver virtual manikin on a driver sitting area portion (that may be in front of vehicle 102 steering wheel) in the vehicle 102 interior portion virtual model, thereby estimating the driver position inside the vehicle 102. In some aspects, the system processor 204 may determine that the driver 126 may be using assistive features/devices (e.g., pedal extensions for disabled driver) to drive the vehicle 102 based on the driver virtual manikin, and may further superimpose manikin of assistive features/devices in the vehicle 102 interior portion virtual model.

Responsive to superimposing the driver virtual manikin on the driver sitting area portion, the system processor 204 may determine whether a driver head portion is in the camera 120 FOV based on vehicle user position estimation. In particular, the system processor 204 may determine whether the driver's eyes (or substantial head portion) are in the camera 120 FOV. Responsive to a determination that the driver head portion is in the camera 120 FOV, the system processor 204 may determine that the alerts generated by the DAT controller 114 may be due to driver's lack of alertness, and hence the alerts may not be false alarms. On the other hand, responsive to a determination that the driver head portion is not in the camera 120 FOV, the system processor 204 may determine that the alerts generated by the DAT controller 114 may be due to the driver head portion not being in the camera 120 FOV (and hence the alerts may be false alarms). Stated another way, the system processor 204 may determine that the reason for the alerts (specifically, the false alarms) may be a driver sitting position inside the vehicle 102, which may cause the driver head portion to not be in the camera 120 FOV.

Responsive to a determination that the reason for the alerts may be the driver sitting position, the system processor 204 may predict or estimate a reason for the driver sitting position inside the vehicle 102. For example, the system processor 204 may determine whether the reason may be the sitting area 124 position, the steering column position, and/or one or more face/eye blocking accessories that may be worn by the driver. In some aspects, the system processor 204 may use machine learning approach or algorithm, such as Gradient Boosted Trees (GBT) algorithm, to predict the reason for the driver sitting position inside the vehicle 102, which may have resulted in the driver head portion not being in the camera 120 FOV. The machine learning algorithm may be trained using simulated/virtual and/or real data. The operation of the system processor 204 may be understood as follows.

In an exemplary aspect, the system processor 204 may obtain the steering column position (e.g., whether the steering wheel 122 is aligned upwards, downwards, inwards or outwards) and the sitting area 124 position (e.g., whether the sitting area 124 is aligned at a lower position or a raised position) from the vehicle information database 208. The system processor 204 may further obtain a plurality of preset scores associated with different steering column positions and sitting area 124 positions from the scoring database 214. In some aspects, the scoring database 214 may store the plurality of preset scores associated with one or more parameters for each steering column position and sitting area 124 position. The parameters may include, but are not limited to, performance, comfort, camera FOV (such as FOV 302, shown in FIG. 3), and/or the like. As an example, the scoring database 214 may store preset scores associated with performance, comfort and camera FOV for each of a raised sitting area 124 position, a lowered sitting area 124 position, an upward aligned steering wheel column, a downward aligned steering wheel column, and/or the like. For example, the scoring database 214 may store preset scores associated with the camera 120 FOV when a steering column angle (e.g., angle “A”, as shown in FIG. 3) is 30 degrees, 60 degrees, etc. The angle “A” may be between a steering column and a vehicle X-axis, as shown in FIG. 3. In an exemplary aspect, the preset scores associated with the camera 120 FOV corresponding to the angle “A” may indicate likelihood of the driver head portion being in the camera 120 FOV, when the angle “A” is 30 degrees, 60 degrees, etc.

Responsive to obtaining the steering column position and the sitting area 124 position, the system processor 204 may determine the scores associated with the steering column position and the sitting area 124 position based on the plurality of preset scores obtained from the scoring database 214. For example, if the steering column position indicates that the steering wheel 122 is aligned upwards, the system processor 204 may determine the preset scores associated with the upward aligned steering wheel 122 alignment from the plurality of preset scores. In a similar manner, the system processor 204 may determine the present scores associated with the sitting area 124 position.

Responsive to determining the preset scores associated with the steering column position and the sitting area 124 position, the system processor 204 may determine differences between the scores associated with the camera FOV parameter for each of the steering column position and the sitting area 124 position and an ideal threshold FOV value. The ideal threshold FOV value may be indicative of the camera 120 FOV (e.g., an FOV 304 shown in FIG. 3) at which the driver head portion may be within the camera 120 FOV. For example, if the ideal threshold FOV value is 0.8, the system processor 204 may determine a difference between a camera FOV score for the steering column position and 0.8 (i.e., the ideal threshold FOV as an example). In a similar manner, the system processor 204 may determine a difference between a camera FOV score for the sitting area 124 position and 0.8. The system processor 204 may further compare the determined differences with a predefined threshold. For example, if the difference between the camera FOV score for the sitting area 124 position and 0.8 is 0.2, and the difference between the camera FOV score for the steering column position and 0.8 is 0.4, the system processor 204 may compare the values of 0.2 and 0.4 with the predefined threshold (which may be, for example, 0.3). In this case, the difference between the camera FOV score for the steering column position and 0.8 (i.e., 0.4) is greater than the predefined threshold (i.e., 0.3). In some aspects, the predefined threshold may be different for the steering column position and the sitting area 124 position.

Responsive to determining that the difference between the camera FOV score for the steering column position and ideal threshold FOV is greater than the predefined threshold, the system processor 204 may determine that the reason for the driver head portion not being in the camera 120 FOV may be the steering column position. In some aspects, the system processor 204 may also determine that the reason for the driver head portion not being in the camera 120 FOV may be both the steering column position and the sitting area 124 position (in case differences for both the positions are greater than the predefined threshold).

A person ordinarily skilled in the art may appreciate that the process of determining the reason, the numerical values and parameters, as described above, are exemplary in nature and should not be construed as limiting the present disclosure scope. For example, in some aspects, the system processor 204 may calculate a collective score for the sitting area 124 position and a collective score for the steering column position. The collective score may be calculated based on individual score on each parameter and respective weight for each parameter (which may be pre-stored in the system memory 206). For example, the system processor 204 may calculate the collective scores by performing weight summation of individual scores for performance, comfort and camera FOV for the sitting area 124 position and the steering column position. Responsive to calculating the collective scores, the system processor 204 may compare each collective score with a threshold value (as described above), and then estimate the reason. Other algorithms for determining the reason based on steering column position and sitting area 124 position are within the scope of the present disclosure.

In some aspects, the system processor 204 may perform the calculations described above locally for a single vehicle/driver. In other aspects, the calculations described above may be performed on a distributed computing system that may be connected to a vehicle fleet. The distributed computing system may perform multiple calculations for one or more vehicles in the vehicle fleet simultaneously. The distributed computing system may “learn” from calculations performed for different vehicles and driver profiles, and may update calculations (e.g., algorithms) and/or weights described above with time, based on the learning.

Responsive to determining the reason, the system processor 204 may determine a solution to assist the driver in adjusting the position. In particular, the system processor 204 may determine an updated vehicle component configuration when the driver head portion is not in the camera 120 FOV, so that the driver head portion may come in the camera 120 FOV. The system processor 204 may determine the updated vehicle component configuration (such as updated sitting area position and/or an updated steering column position that may increase driver's FOV) based on the estimated vehicle user position. Specifically, the system processor 204 may determine the updated vehicle component configuration based on the determined reason. For example, when the system processor 204 determines that the reason for the driver head portion not being in the camera 120 FOV is the steering column position (e.g., the steering column may be upward inclined, as shown in FIG. 3), the system processor 204 may provide determine an updated steering column position as being rotated downwards by a specific angle (e.g., by 20 degrees).

In some aspects, the system processor 204 may determine the updated vehicle component configuration such that the driver head portion may come in the camera 120 FOV, and such that the performance and comfort scores may remain above respective threshold values. For example, if the driver head portion may come in the camera 120 FOV by rotating the steering column by 20 degrees and also by 30 degrees, however rotating the steering column by 30 degrees may cause driver discomfort (e.g., the corresponding comfort score may be less than a comfort threshold value), the system processor 204 may not determine rotating the steering wheel column by 30 degrees as an updated steering column position.

Responsive to determining the updated vehicle component configuration, the system processor 204 may transmit, via the system transceiver 202, the updated vehicle component configuration (as feedback to adjust the driver position) to the vehicle 102 or the server 104, to enable the driver to adjust the position according to the updated vehicle component configuration. In some aspects, the system processor 204 may transmit the updated vehicle component configuration to a user interface (such as a vehicle infotainment system), via the vehicle transceiver 118. In other aspects, the system processor 204 may transmit the updated vehicle component configuration to a user device (such as user's mobile phone), via the server 104. In further aspects, the system processor 204 may transmit the updated vehicle component configuration as an audio and/or video feedback. In some aspects, the system processor 204 may store the updated vehicle component configuration in the vehicle information database 208.

In further aspects, the system processor 204 may transmit the updated vehicle component configuration to the DAT controller 114, via the vehicle transceiver 118. The DAT controller 114 may obtain the updated vehicle component configuration and may perform automatic vehicle component adjustment. For example, the DAT controller 114 may automatically adjust the sitting area 124 inclination, sitting area 124 height, steering column position, and/or the like, based on the updated vehicle component configuration.

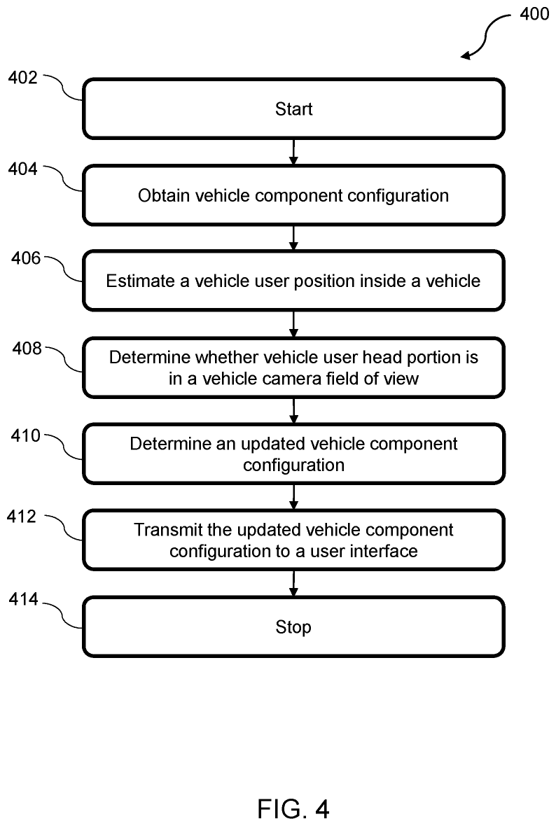

FIG. 4 depicts a flow diagram of an example method 400 for providing driver position assistance, in accordance with the present disclosure. FIG. 4 may be described with continued reference to prior figures, including FIGS. 1-3. The following process is exemplary and not confined to the steps described hereafter. Moreover, alternative embodiments may include more or less steps that are shown or described herein and may include these steps in a different order than the order described in the following example embodiments.

Referring to FIG. 4, at step 402, the method 400 may commence. At step 404, the method 400 may include obtaining, by the system processor 204, the vehicle component configurations. In particular, the system processor 204 may obtain the vehicle component configurations from the vehicle 102, as described above. The vehicle component configurations may include the sitting area 124 configuration (sitting area 124 height, sitting area 124 inclination etc.), steering column configuration (steering column position e.g., whether the steering column is up, down, or out), etc.

At step 406, the method 400 may include estimating, by the system processor 204, the driver position inside the vehicle 102. In particular, the system processor 204 may obtain user/driver profile, and may generate the driver virtual manikin. In further aspects, the system processor 204 may generate the virtual vehicle 102 model based on the obtained vehicle component configurations. The system processor 204 may estimate the driver position inside the vehicle 102 inside the vehicle 102 by positioning or superimposing the virtual manikin on the virtual vehicle 102 model, as described above in conjunction with FIG. 2.

At step 408, the method 400 may include determining, by the system processor 204, whether the driver head portion is in the camera 120 FOV based on driver position estimation inside the vehicle 102. If the system processor 204 determines that the driver head portion is in the camera 120 FOV, the system processor 204 may determine that the driver alertness detection system may not have generated false alarms, as described above.

On the other hand, responsive to determining that the driver head portion is not in the camera 120 FOV, at step 410, the method 400 may include determining, by the system processor 204, the updated vehicle component configuration based on the estimated driver position inside the vehicle 102. As described above in conjunction with FIG. 2, the system processor 204 may determine the reason for the driver head portion not being in the camera 120 FOV, and then accordingly determine updated vehicle component configuration such that the driver head portion comes in the camera 120 FOV.

At step 412, the method 400 may include transmitting, via the system processor 204 and the system transceiver 202, the updated vehicle component configuration to the user interface, e.g., a user device or a vehicle 102 infotainment system.

The method 400 stops at step 414.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A driver position assist system comprising:
a transceiver configured to receive a vehicle component configuration from a vehicle; and
a processor communicatively coupled to the transceiver, wherein the processor is configured to:
obtain the vehicle component configuration from the transceiver;
estimate a vehicle user position inside the vehicle based on the vehicle component configuration;
determine whether a vehicle user head portion is in a vehicle camera field of view (FOV) based on the estimation of the vehicle user position;
determine an updated vehicle component configuration based on the vehicle user position when the vehicle user head portion is not in the vehicle camera FOV; and
transmit, via the transceiver, the updated vehicle component configuration to a user interface.

2. The driver position assist system of claim 1, wherein the vehicle component configuration comprises a sitting area position and a steering column position.

3. The driver position assist system of claim 2, wherein the processor determines the updated vehicle component configuration by determining an updated sitting area position and/or an updated steering column position.

4. The driver position assist system of claim 1, wherein the transceiver is further configured to receive a vehicle user profile.

5. The driver position assist system of claim 4, wherein the processor is further configured to:
obtain the vehicle user profile from the transceiver;
generate a virtual manikin based on the vehicle user profile;
generate a virtual vehicle model based on the vehicle component configuration;
position the virtual manikin in the virtual vehicle model; and
estimate the vehicle user position inside the vehicle responsive to positioning the virtual manikin.

6. The driver position assist system of claim 1, wherein the processor is further configured to:
obtain sensor data from the vehicle; and
predict a vehicle user profile based on the sensor data.

7. The driver position assist system of claim 6, wherein the processor is further configured to:
generate a virtual manikin based on the vehicle user profile;
generate a virtual vehicle model based on the vehicle component configuration;
position the virtual manikin in the virtual vehicle model; and
estimate the vehicle user position inside the vehicle responsive to positioning the virtual manikin.

8. The driver position assist system of claim 1, wherein the processor is further configured to:
determine a reason for the vehicle user head portion not being in the vehicle camera FOV based on the vehicle user position, when the vehicle user head portion is not in the vehicle camera FOV; and
determine the updated vehicle component configuration based on the reason.

9. A driver position assistance method comprising:
obtaining, by a processor, a vehicle component configuration from a vehicle;
estimating, by the processor, a vehicle user position inside the vehicle based on the vehicle component configuration;
determining, by the processor, whether a vehicle user head portion is in a vehicle camera field of view (FOV) based on the estimation of the vehicle user position;
determining, by the processor, an updated vehicle component configuration based on the vehicle user position when the vehicle user head portion is not in the vehicle camera FOV; and
transmitting, by the processor, the updated vehicle component configuration to a user interface.

10. The driver position assistance method of claim 9, wherein the vehicle component configuration comprises a sitting area position and a steering column position.

11. The driver position assistance method of claim 9, wherein determining the updated vehicle component configuration comprises determining an updated sitting area position and/or an updated steering column position.

12. The driver position assistance method of claim 9 further comprising:
obtaining a vehicle user profile;
generating a virtual manikin based on the vehicle user profile;
generating a virtual vehicle model based on the vehicle component configuration;
positioning the virtual manikin in the virtual vehicle model; and
estimating the vehicle user position inside the vehicle responsive to positioning the virtual manikin.

13. The driver position assistance method of claim 9 further comprising:
obtaining a sensor data from the vehicle; and
predicting vehicle user's profile based on the sensor data.

14. The driver position assistance method of claim 13 further comprising:
generating a virtual manikin based on the vehicle user's profile;
generating a virtual vehicle model based on the vehicle component configuration;
positioning the virtual manikin in the virtual vehicle model; and
estimating the vehicle user position inside the vehicle responsive to positioning of the virtual manikin.

15. A non-transitory computer-readable storage medium having instructions stored thereupon which, when executed by a processor, cause the processor to:
obtain a vehicle component configuration from a vehicle;
estimate a vehicle user position inside the vehicle based on the vehicle component configuration;
determine whether a vehicle user head portion is in a vehicle camera field of view (FOV) based on the estimation of the vehicle user position;
determine an updated vehicle component configuration based on the vehicle user position when the vehicle user head portion is not in the vehicle camera FOV; and
transmit the updated vehicle component configuration to a user interface.

16. The non-transitory computer-readable storage medium of claim 15, wherein the vehicle component configuration comprises a sitting area position and a steering column position.

17. The non-transitory computer-readable storage medium of claim 15, wherein the determination of the updated vehicle component configuration comprises determination of an updated sitting area position and/or an updated steering column position.

18. The non-transitory computer-readable storage medium of claim 15, having further instructions stored thereupon to:
obtain a vehicle user profile;
generate a virtual manikin based on the vehicle user profile;
generate a virtual vehicle model based on the vehicle component configuration;
position the virtual manikin in the virtual vehicle model; and
estimate the vehicle user position inside the vehicle responsive to positioning the virtual manikin.

19. The non-transitory computer-readable storage medium of claim 15, having further instructions stored thereupon to:
obtain a sensor data from the vehicle; and
predict vehicle user's profile based on the sensor data.

20. The non-transitory computer-readable storage medium of claim 19, having further instructions stored thereupon to:
generate a virtual manikin based on the vehicle user's profile;
generate a virtual vehicle model based on the vehicle component configuration;
position the virtual manikin in the virtual vehicle model; and
estimate the vehicle user position inside the vehicle responsive to positioning of the virtual manikin.
